(19) United States
(12) Patent Application Publication
(10) Pub. No.: US 2009/0118155 A1
(43) Pub. Date: May 7, 2009

(54) Liquid Whitening Maintenance Composition

(76) Inventors: Stephen Norman Batchelor, Wirral (GB); Jayne Michelle Bird, Wirral (GB); Carol Meacock, Wirral (GB); Dawn Rigby, Wirral (GB); Jacqueline Williams, Wirral (GB)

Correspondence Address: UNILEVER PATENT GROUP, 800 SYLVAN AVENUE, AG West S. Wing, ENGLEWOOD CLIFFS, NJ, 07632-3100, US

(21) Appl. No.: 12/224,247

(22) PCT Filed: Feb. 7, 2007
(86) PCT No.: PCT/EP2007/001161

§ 371 Date: Aug. 21, 2008

(51) Int. Cl. C11D 3/40; C11D 1/83

(52) U.S. Cl. 510/343; 510/340

(57) ABSTRACT

The present invention provides a liquid laundry liquid detergent formulation comprising a dye that reduces precipitation of the dye.

### FIELD OF INVENTION

The present invention relates to laundry treatment compositions comprising a dye.

### BACKGROUND OF THE INVENTION

U.S. Pat. No. 4,800,037 and U.S. Pat. No. 4,110,238 discloses the use of solvent blue 58, a hydrophobic anthraquinone dye containing a C8 chain at levels of 0.005 to 0.025 wt % in a laundry liquid formulation. The long alkyl chain helps to solubilise the dye in the liquid formulation. Additionally the formulation contains a hydrotrope to solubilise the dye.

### SUMMARY OF THE INVENTION

Shading dyes impart a colour to a textile. The dyes are substantive to the textile and preferably are blue of violet in order to give a perception of whiteness. This perception of whiteness is of importance as textile clothing ages. Hydrophobic dyes are used to shade synthetic garments.

For main wash liquid detergent formulations that contain shading dyes, the shading dye needs to remain solubilised as best as possible in the liquid formulation from the time of production to the time of use in the home. Even in the presence of surfactants hydrophobic dyes precipitate from solution with time. The liquid formulations of the present invention reduce this precipitation.

In one embodiment the present invention provides an aqueous laundry liquid detergent formulation comprising:
(a) 0.000001 to 0.01% of a hydrophobic dye
(b) between 10 to 50 wt % of a surfactant mixture, the surfactant mixture comprising: (i) a non-ionic surfactant; and (ii) an anionic surfactant selected from the group consisting of: linear alkyl benzene sulphonate (LAS), alkyl sulphate, and alkyl ethoxylated sulphate, and,
(c) that balance adjuncts to 100 wt %,
   wherein the ratio of the total content of linear alkyl benzene sulphonate and alkyl sulphate:non-ionic:alkyl ethoxylated sulphate is 1:0.5 to 3:0.5 to 3, and the alkyl ethoxylated sulphate is an alkyl ethoxylated sulphate having between 1.0 to 1.5 ethylene oxide units.

Furthermore, in a second aspect the invention provides a method of treating textile, comprising the steps of:
a) diluting from 0.5 to 20 g of the liquid detergent formulation according to the present invention with 1 litre of water to form a diluted composition;
b) treating the textile with the diluted composition;
c) rinsing the textile with water; and
d) drying the textile.

Treatment is preferably carried out in the domestic context, at temperature between 10 to 60° C., preferably 15 to 40° C.

### DETAILED DESCRIPTION OF THE INVENTION

The water present in the aqueous laundry liquid detergent formulation is preferably at a level of at least 40 wt %.

A preferred ratio of the total content of linear alkyl benzene sulphonate and alkyl sulphate:non-ionic:alkyl ethoxylated sulphate group is 1:1.5 to 2.5:1.5 to 2.5.

The dye level is preferably from 0.0002 to 0.004%.

All percentages and ratios are expressed with respect to weight.

Surfactant

The liquid composition of the invention comprises from 10 to 50 wt %, preferably from 12 to 25% by weight of a surfactant mixture.

Linear alkyl benzene sulphonates salts (LAS), particularly C₁₁-C₁₈ alkylbenzene sulphonates in the form of the sodium salt.

Alkyl sulphate surfactants are either primary or secondary. Alkyl sulphates have the general formula ROSO₃M wherein R is preferably a C₁₀-C₂₄ hydrocarbyl, preferably an alkyl straight or branched chain or hydroxyalkyl having a C₁₀-C₂₀ alkyl component, more preferably a C₁₂-C₁₈ alkyl or hydroxyalkyl, and M is hydrogen or a water soluble cation, e.g., an alkali metal cation (e.g., sodium potassium, lithium). Particularly preferred is sodium dodecyl sulphate (SDS).

Alkyl ethoxylated sulphate surfactants are another category of preferred anionic surfactant. These surfactants are water soluble salts or acids typically of the formula RO(A)mSO₃M wherein R is an unsubstituted C₁₀-C₂₄ alkyl or hydroxyalkyl group having a C₁₀-C₂₄ alkyl component, preferably a C₁₂-C₂₀ alkyl or hydroxyalkyl, more preferably C₁₂-C₁₈ alkyl or hydroxyalkyl, A is an ethoxy, m is between 1 and 2, more preferably between 1 and 1.5, most preferably 1 and M is hydrogen or a water soluble cation which can be, for example, a metal cation (e.g., sodium, potassium, lithium, calcium, magnesium, etc.), ammonium or substituted-ammonium cation. With respect to the above, propoxylated sulphates may also be used. Sodium lauryl ether sulphates are most preferred.

Non-ionic surfactant, particularly alcohol ethoxylates, R—(OCH₂CH₂)ₙOH, where R is an alkyl chain typically C10 to C18, preferably C12 to C15, and n is 3 to 20, preferably 7 to 9, most preferred n=9. Other non-ionic surfactant may be selected from C₆-C₁₂ alkyl phenol alkoxylates (especially ethoxylates and mixed ethoxy/propoxy), block alkylene oxide condensate of C₆ to C₁₂ alkyl phenols, alkylene oxide condensates of C₈-C₂₂ alkanols and ethylene oxide/propylene oxide block polymers (Pluronic™-BASF Corp.).

Further minor surfactants may be added include cationics, soaps, betaines, alkylpolyglycosides, N-methyl glucomides.

It is preferred that the minor surfactants are present at levels of less than 3%.

The Hydrophobic Dye

Typical dye suppliers may be found in the colour index, and include Clariant, Dystar, Ciba & BASF.

Hydrophobic dyes are defined as organic compounds with a maximum extinction coefficient greater than 1000 L/mol/cm in the wavelength range of 400 to 750 nm and that are uncharged in aqueous solution at a pH in the range from 7 to 11. The hydrophobic dyes are devoid of polar solubilising groups. In particular the hydrophobic dye does not contain any sulphonic acid, carboxylic acid, or quaternary ammonium groups. The dye chromophore is preferably selected from the group comprising: azo; methine, pyrazole, anthraquinone, napthoquinone, napthalimides, phthalocyanine; and, triphenylmethane chromophores. Of the azo dyes, mono-azo or di-azo dyes are preferred. Most preferred are azo dye and anthraquinone chromophores.

Many examples of hydrophobic dyes are found in the classes of solvent and disperse dyes.

Shading of white garments may be done with any colour depending on consumer preference. Blue and Violet are particularly preferred shades and consequently preferred dyes or mixtures of dyes are ones that give a blue or violet shade on white polyester.

It is preferred that the dye(s) have a peak absorption wavelength of from 550 nm to 650 nm, preferably from 570 nm to 630 nm. A combination of dyes may be used which together have the visual effect on the human eye as a single dye having a peak absorption wavelength on polyester of from 550 nm to 650 nm, preferably from 570 nm to 630 nm. This may be provided for example by mixing a red and green-blue dye to yield a blue or violet shade.

A wide range of suitable solvent and disperse dyes are available. However detailed toxicological studies have shown that a number of such dyes are possible carcinogens, such dyes are not preferred.

Preferred mono-azo dyes are of the form:

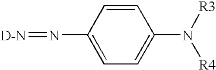

wherein R3 and R4 are optionally substituted C₂ to C₁₂ alkyl chains having optionally therein ether (—O—) or ester links, the chain being optionally substituted with —Cl, —Br, —CN, —NO₂, and —SO₂CH₃; and, D denotes an aromatic or heteroaromatic group. Preferably D is selected from the group consisting of: azothiophenes, azobenzothiazoles and azopyridones.

It is preferred that R3 is —CH2CH2R5 and R4 and is —CH2CH2R6 and R5 and R6 are independently selected from the group consisting of: H, —CN, —OH, —C6H5, —OCOR7 and —COOR7, and that R7 is independently selected from: aryl and alkyl. Preferred aryl are —C6H5 and C10H7.

The following is an example of a preferred class of mono-azo dyes:

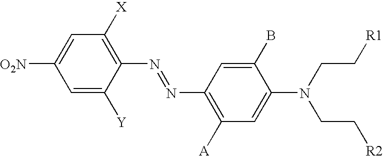

where X and Y are independently selected from the group consisting of: —H, —Cl, —Br, —CN, —NO₂, and —SO₂CH₃;

A is selected —H, —CH₃, —Cl, and —NHCOR;

B is selected —H, —OCH₃, —OC₂H5, and —Cl;

R¹ and R² are independently selected from the group consisting of: —H, —CN, —OH, —OCOR, —COOR, -aryl; and

R is C₁-C₈-alkyl.

The following are preferred azo dyes: Disperse blue 10, 11, 12, 21, 30, 33, 36, 38, 42, 43, 44, 47, 79, 79:1, 79:2, 79:3, 82, 85, 88, 90, 94, 96, 100, 101, 102, 106, 106:1, 121, 122, 124, 125, 128, 130, 133, 137, 138, 139, 142, 146, 148, 149, 165, 165:1, 165:2, 165:3, 171, 173, 174, 175, 177, 183, 187, 189, 193, 194, 200, 201, 202, 205, 206, 207, 209, 210, 211, 212, 219, 220, 222, 224, 225, 248, 252, 253, 254, 255, 256, 257, 258, 259, 260, 264, 265, 266, 267, 268, 269, 270, 278, 279, 281, 283, 284, 285, 286, 287, 290, 291, 294, 295, 301, 303, 304, 305, 313, 315, 316, 317, 319, 321, 322, 324, 328, 330, 333, 335, 336, 337, 338, 339, 340, 341, 342, 343, 344, 345, 346, 351, 352, 353, 355, 356, 358, 360, 366, 367, 368, 369, 371, 373, 374, 375, 376 and 378, Disperse Violet 2, 3, 5, 6, 7, 9, 10, 12, 13, 16, 24, 25, 33, 39, 42, 43, 45, 48, 49, 50, 53, 54, 55, 58, 60, 63, 66, 69, 75, 76, 77, 82, 86, 88, 91, 92, 93, 93:1, 94, 95, 96, 97, 98, 99, 100, 102, 103, 104, 106 or 107, Dianix violet cc, and dyes with CAS-No's 42783-06-2, 210758-04-6, 104366-25-8, 122063-39-2, 167940-11-6, 52239-04-0, 105076-77-5, 84425-43-4, and 87606-56-2.

The following are preferred non-azo dyes: Disperse Blue 250, 354, 364, 366, Solvent Violet 8, solvent blue 43, solvent blue 57, Lumogen F Blau 650, and Lumogen F Violet 570 (both ex BASF).

Preferred anthraquinone dyes are of the following structure (I):

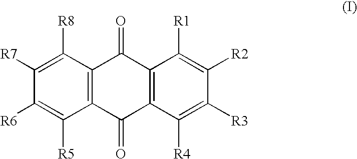

wherein R1, R4, R5, and R8 are independently selected from the groups consisting of —H, —OH, —NH₂, —NHR9, and —NO₂, such that a maximum of only one —NO2 group and a maximum of two —H are present as R1, R4, R5, and R8 substituents; where R9 is an branched or linear C1-C7-alkyl chain or an aryl group or substituted aryl groups, or a branched or linear C1-C7-alkyl chain, the branched or linear C1-C7-alkyl chain is preferably not substituted by an —OH group or —OMe; R2, R3, R6, and R7 may be selected from —H, —F, —Br, —Cl, SO3aryl or —NO₂, and —OR10, wherein R10 is selected from the group consisting of branched or linear C1-C7-alkyl or aryl; and, R2 and R3 may together be joined to form a five membered non-aromatic ring of the form —C(═O)N(HR11)C(═X)—, wherein X is O or NH and R11 is selected from the group consisting of C1-C6-alkyl optionally substituted with alkoxy groups. It is preferred that if R9 and/or R10 is a branched or linear alkyl chain then the chain has less than six carbon atoms and does not have an OH or OMe substituent.

It is preferred that the R9 and R10 are not branched or linear alkyl chains; R9 and R10 may be methyl, i.e., not a chain. It is preferred that R2 and R3 are individual substituents and are not covalently bound together to form a ring. In particular, it is preferred that R2 and R3 are not joined to form a five membered non-aromatic ring of the form —C(═O)N(HR11)C(═X)—, wherein X is O or NH and R11 is selected from the group consisting of C₁-C₆-alkyl optionally substituted with alkoxy groups.

It is preferred that R1, R4, R5, and R8 are independently selected from the groups consisting of —H, —OH, —NH₂, and —NO₂, and R2, R3, R6, and R7 is selected from —H, F, Br, Cl or —NO₂, and —Oaryl. It is also preferred that the aryl is an optionally substituted phenyl. Of the R1, R4, R5 and R8 it is most preferred that is —OH and one is selected from —NH2 and —NHR9.

It is preferred that R2, R3, R5, R6, R7, and R8 are —H, R1=-OH, R4=—NHR9 or —NH2.

It is preferred that R5, R6, R7, and R8=-H, R1=R4=—NH2, R2=R3=-Oaryl, or —Cl.

Most preferred dyes are disperse blue 56, solvent violet 13, disperse violet 26 and disperse violet 28.

It is preferred that disperse blue 87 and disperse blue 7 are excluded from the hydrophobic dye of the anthraquinone structure.

The composition may also comprise between 0.0001 to 0.1 wt % of one or more other dyes selected from cotton substantive shading dyes of group consisting of: hydrolysed reactive dye; acid dye; and direct dye. Example of preferred acid dyes are: acid blue 62, 40 and 290.

Balance Adjuncts of the Liquid Formulation

Preferably the aqueous liquid detergent formulation has a pH-value between 6 and 12, more preferably between 7 and 10, even more preferably between 7.5 and 9.5. When the pH-value of the detergent composition of the invention is below 7.5, the presence of a pH jump system, i.e. a system that increase the pH-value to above 7.5 on dilution with water, is beneficial for the cleaning performance of said composition.

The liquid detergent composition of the invention may additionally comprise builders, solvents, perfumes, sequestrants, polymers, preservatives, fluorescers, dyes, biocides, buffers, salts.

Suitable detergency builders as optional, but preferred, ingredients may also be present, as found in WO-00/34427. One salt of particular interest is citrate, because of its additional builder and bleaching characteristics.

The following are also preferred adjuncts.

Perfumes

The liquid formulation of the present invention preferably comprises between 0.001 to 3% by weight of a perfume composition, more preferably between 0.1 to 2% by weight of a perfume composition. Said perfume composition preferably comprises at least 0.01% by weight based on the liquid composition of a perfume component selected from terpenes, ketones, aldehydes and mixtures thereof. The perfume composition may fully consist of the perfume component but generally the perfume composition is a complex mixture of perfumes of various differing perfume classifications. In this regard, the perfume composition preferably comprises 0.1 to 2% by weight of the perfume component.

Antioxidant

The liquid detergent composition of the invention preferably comprise between 0.001 to 2% by weight of an antioxidant. Preferably, the antioxidant is present at a concentration in the range 0.01 to 0.08% by weight. Anti-oxidants are substances as described in Kirk-Othmers (Vol 3, pg 424) and in Uhlmans Encyclopedia (Vol 3, pg 91). An example of a preferred antioxidant is BHT.

Fluorescent Agent

The laundry treatment composition most preferably comprises a fluorescent agent (optical brightener). Fluorescent agents are well known and many such fluorescent agents are available commercially. Usually, these fluorescent agents are supplied and used in the form of their alkali metal salts, for example, the sodium salts. The total amount of the fluorescent agent or agents used in laundry treatment composition is generally from 0.005 to 2 wt %, more preferably 0.01 to 0.1 wt %. Preferred classes of fluorescer are: Di-styryl biphenyl compounds, e.g. Tinopal (Trade Mark) CBS-X, Di-amine stilbene di-sulphonic acid compounds, e.g. Tinopal DMS pure Xtra and Blankophor (Trade Mark) HRH, and Pyrazoline compounds, e.g. Blankophor SN. Preferred fluorescers are: sodium 2 (4-styryl-3-sulfophenyl)-2H-napthol[1,2-d]trazole, disodium 4,4′-bis{[(4-anilino-6-(N methyl-N-2 hydroxyethyl)amino 1,3,5-triazin-2-yl)]amino}stilbene-2-2′disulfonate, disodium 4,4′-bis{[(4-anilino-6-morpholino-1,3,5-triazin-2-yl)]amino}stilbene-2-2′disulfonate, and disodium 4,4′-bis(2-sulfoslyryl)biphenyl.

### EXAMPLES

Model Liquid detergent composition were created containing 15% total surfactant and 0.0004% of the dye solvent violet 13. The surfactants were chosen from LAS, SDS, SLES(1EO), SLES(3EO), and two non-ionic surfactants:

non-ionic NI(7EO)—Neodol 25-7 which is a mixture of 12 to 15 carbon chain length alcohols with about 7 ethylene oxide groups per molecule and NI(9EO)—Neodol 25-9, a C12-13 mixture with about 9 moles of ethylene oxide.

The dye was added from a concentrated mix in the corresponding non-ionic of the formulation.

The detergents were left for 5 days then the UV-VIS spectrum measured using a 5 cm cell. The optical density at 590 nm was recorded (maximum of the dye) and 750 nm where there is negligible absorbance from the dye. The base surfactant has negligible absorbance at 590 and 750 nm. The 750 nm was made to measure scattering from dye particles that were not fully dissolved. These measurements are referred to as day 0.

The formulations were left at room temperature in the dark for 8 days then the spectra re-recorded. The relative amount of dye that remain solubilised in solution compared to the initial measurement, % dye8, was calculated using the following equation:

$$\% dye 8 = 100 * \frac{[ OD ( 590 nm , day 8 ) - OD ( 750 nm , day 8 ) ]}{[ OD ( 590 nm , day 0 ) - OD ( 750 nm , day 0 ) ]}$$

The 750 nm subtraction corrects for scattering effects. The results are summarised in the tables and discussions below. The values greater than 100% indicate that with time more dye becomes solubilised.

TABLE 1.1
mixtures of LAS or SDS with non-ionic containing
medium levels of SLES.

| Surfactant mix | % dye 8 |
|---|---|
| 6% LAS, 6% NI(9EO), 3% SLES(1EO) | 109% |
| 6% LAS, 6% NI(9EO), 3% SLES(3EO) | 76% |
| 6% LAS, 6% NI(7EO), 3% SLES(1EO) | 98% |
| 6% LAS, 6% NI(7EO), 3% SLES(3EO) | 82% |
| 6% SDS, 6% NI(9EO), 3% SLES(1EO) | 109% |
| 6% SDS, 6% NI(9EO), 3% SLES(3EO) | 81% |
| 6% SDS, 6% NI(7EO), 3% SLES(1EO) | 111% |
| 6% SDS, 6% NI(7EO), 3% SLES(3EO) | 75% |

The table shows that mixtures of LAS or SDS with non-ionic containing medium levels of SLES (1EO), effectively solubilise the dye over long periods of time. NI(9Eo) containing mixtures performed better over NI(7EO). Mixtures containing SLES (3Eo) do not effectively solubilise the dye over long period of time.

TABLE 1.2
mixtures of SLES and non-ionic with medium levels
of LAS or SDS.

| Surfactant mix | % dye 8 |
|---|---|
| 3% LAS, 6% NI(9EO), 6% SLES(1EO) | 124% |
| 3% LAS, 6% NI(7EO), 6% SLES(1EO) | 101% |
| 3% LAS, 6% NI(7EO), 6% SLES(3EO) | 76% |
| 3% SDS, 6% NI(9EO), 6% SLES(1EO) | 123% |
| 3% SDS, 6% NI(9EO), 6% SLES(3EO) | 71% |
| 3% SDS, 6% NI(7EO), 6% SLES(1EO) | 109% |
| 3% SDS, 6% NI(7EO), 6% SLES(3EO) | 69% |

The table shows that mixtures of SLES (1EO) and non-ionic with medium levels of LAS or SDS effectively solubilise the dye over long periods of time. NI(9EO) containing mixtures performed better over NI(7EO). Mixtures containing SLES (3EO) do not effectively solubilise the dye over long period of time.

### Example 2

When the liquid formulations of example 1 were used to wash white polyester, nylon and nylon elastane fabrics at room temperature with a dose 1.8 g/L and a L:C of 100:1, clear deposition of the dye to the fabrics was observed giving better whiteness. This occurred when the product was buffered to pH 8 and pH 11.

1. An aqueous laundry liquid detergent formulation comprising:
(a) 0.000001 to 0.01% of a hydrophobic dye
(b) between 10 to 50 wt % of a surfactant mixture, the surfactant mixture comprising: (i) a non-ionic surfactant; and (ii) an anionic surfactant selected from the group consisting of: linear alkyl benzene sulphonate (LAS), alkyl sulphate, and alkyl ethoxylated sulphate, and,
(c) that balance adjuncts to 100 wt %,
wherein the ratio of the total content of linear alkyl benzene sulphonate and alkyl sulphate:non-ionic:alkyl ethoxylated sulphate is 1:0.5 to 3:0.5 to 3, and the alkyl ethoxylated sulphate is an alkyl ethoxylated sulphate having between 1.0 to 1.5 ethylene oxide units.

2. An aqueous laundry liquid detergent formulation according to claim 1, wherein the ratio of the total content of linear alkyl benzene sulphonate and alkyl sulphate:non-ionic:alkyl ethoxylated sulphate group is 1:1.5 to 2.5:1.5 to 2.5.

3. An aqueous laundry liquid detergent formulation according to claim 1, wherein the non-ionic is an alcohol ethoxylate, the alkyl ethoxylated sulphate is a sodium lauryl ether sulphate, and the alkyl sulphate is sodium dodecyl sulphate.

4. An aqueous laundry liquid detergent formulation according to claim 1, wherein the non-ionic is chosen from alcohol ethoxylate containing a carbon chain of 12 to 15 carbons and 7 to 9 ethylene oxide groups

5. An aqueous laundry liquid detergent formulation according to claim 1, wherein the alcohol ethoxylate contains 9 ethylene oxide groups.

6. An aqueous laundry liquid detergent formulation according to claim 1, wherein the hydrophobic dye is an anthraquinone benzodifuranes, methine, triphenylmethanes, napthalimides, pyrazole, napthoquinone and mono-azo or di-azo dyes.

7. An aqueous laundry liquid detergent formulation according to claim 6, wherein the hydrophobic dye is blue or violet and selected from: a) mono-azo dyes and b) anthraquinones which do not contain alkyl chains.

8. An aqueous laundry liquid detergent formulation according to claim 6, wherein the hydrophobic dye is selected from solvent violet 13, disperse blue 56, disperse violet 26 and disperse violet 28.

9. An aqueous laundry liquid detergent formulation according to claim 6, wherein the hydrophobic dye is selected from disperse blue 79:1, disperse blue 165, Dianix Violet CC (ex Dystar), disperse violet 63, disperse violet 77 and disperse blue 148.

10. An aqueous laundry liquid detergent formulation according to claim 6, wherein dye is solvent violet 13.

11. An aqueous laundry liquid detergent formulation according to claim 1, dye level is 0.0002 to 0.004%

12. An aqueous laundry liquid detergent formulation according to claim 1, wherein the surfactant mixture is present in the range 12 to 25 wt %.

13. An aqueous laundry liquid detergent formulation according to claim 1, wherein a surfactant other than defined in claim 1 is present at a levels of less than 3 wt %.
